(19) United States
(12) Patent Application Publication
(10) Pub. No.: US 2008/0109545 A1
(43) Pub. Date: May 8, 2008

(54) METHOD AND SYSTEM FOR TWO-PHASE MECHANISM FOR DISCOVERING WEB SERVICES BASED MANAGEMENT SERVICE

(76) Inventor: Hemal Shah, Trabuco Canyon, CA (US)

Correspondence Address: MCANDREWS HELD & MALLOY, LTD, 500 WEST MADISON STREET, SUITE 3400, CHICAGO, IL, 60661, US

(21) Appl. No.: 11/933,713

(22) Filed: Nov. 1, 2007

Related U.S. Application Data
(60) Provisional application No. 60/864,078, filed on Nov. 2, 2006.

(51) Int. Cl. G06F 15/173

(52) U.S. Cl. 709/223

(57) ABSTRACT

A management device may determine the presence of WS-Management services in a network device, and may discover capabilities of discovered WS-Management services in the network device. The management device may determine the presence of the WS-Management services utilizing a unicast ping mechanism in instances where the MAC and/or IP address of the network device may be known or a broadcast ping mechanism may be utilized in instances when the MAC and/or IP address is unknown. The discovery of capabilities of the WS-Management services may be performed via direct communication between the devices, and may utilize WS-Management based messaging. The direct communication may utilize specific HTTP ports when utilizing WS-Management based messaging. Where WS-Management and ASF services may coexist in the network device, the management device may additionally perform discovery of capabilities of ASF services, and may utilize ASF based messaging to perform discovery of capabilities of discovered ASF services.

### CROSS-REFERENCE TO RELATED APPLICATIONS/INCORPORATION BY REFERENCE

This patent application makes reference to, claims priority to and claims benefit from U.S. Provisional Application Ser. No. 60/864,078 filed on Nov. 2, 2006.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to network management. More specifically, certain embodiments of the invention relate to a method and system for a two-phase mechanism for discovering web services based management service.

### BACKGROUND OF THE INVENTION

Information Technology (IT) management may require performing remote management operations of remote systems to perform inventory and/or to determine whether remote systems are up-to-date. Remote management operations may either be performed in-band, wherein operating system (OS) run in said remote system may be utilized to facilitate said remote management operations; or alternatively, remote management operations may be performed out-of-band, wherein OS may not be necessarily be running during such management operations.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a two-phase mechanism for discovering web services based management service, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary communication setup between a management device and a network device, which may be utilized in accordance with an embodiment of the invention.

FIG. 2A is a flow diagram that illustrates exemplary messaging during out-of-band management between a management device and a network device via two-phase mechanism utilizing WS-Management service messaging in the second phase, in accordance with an embodiment of the invention.

FIG. 2B is a flow diagram that illustrates exemplary messaging during out-of-band management between a management device and a network device via two-phase mechanism utilizing ASF messaging in the second phase, in accordance with an embodiment of the invention.

FIG. 2C is a flow diagram that illustrates exemplary messaging during out-of-band management between a management device and a network device via two-phase mechanism utilizing both WS-Management service and ASF messaging in the second phase, in accordance with an embodiment of the invention.

FIG. 3A is a flow diagram that illustrates a first phase of a two-phase mechanism that enables out-of-band management between a management device and a network device, in accordance with an embodiment of the invention.

FIG. 3B is a flow diagram that illustrates a second phase of a two-phase mechanism that enables out-of-band management between a management device and a network device, in accordance with an embodiment of the invention.

### DETAILED DESCRIPTION OF THE INVENTION

Certain embodiments of the invention may be found in a method and system for a two-phase mechanism for discovering web services based management service. A management device may determine the presence of WS-Management services in a network device, and may discover capabilities of discovered WS-Management services in the network device. The management device may determine the presence of the WS-Management services utilizing a unicast ping mechanism in instances where the MAC and/or IP address of the network device may be known. The management device may determine the presence of the WS-Management services utilizing a broadcast ping mechanism in instances where the MAC and/or IP address of the network device may be unknown. The remote management agent may determine the presence of the WS-Management service utilizing a ping sweep in instances where the MAC and/or IP addresses of the management services may be known. The discovery of capabilities of discovered WS-Management services may be performed via direct communication between the management device and the network device; and the direct communication may utilize WS-Management based messaging. Additionally, the direct communication between the management device and the network device may utilize specific HTTP ports when utilizing WS-Management based messaging. In instances where it may be determined that WS-Management and ASF services may coexist in the network device, the management device may perform discovery of capabilities of ASF services in addition to discovery of capabilities of discovered WS-Management services. The management device may utilize ASF based messaging to perform discovery of capabilities of discovered ASF services during direct communication between the management device and the network device. The management device may optionally discover capabilities of existing WS-Management and/or ASF services in the network device indirectly. In this regard, the network device may advertise capabilities of existing WS-Management and/or ASF services in the network device via external entities.

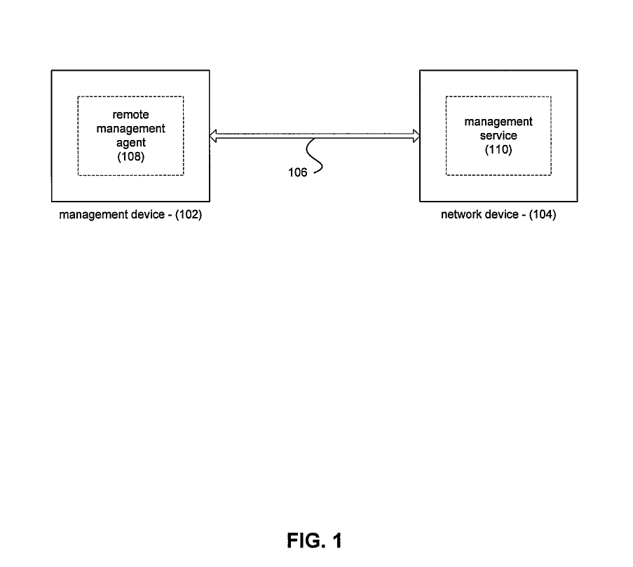

FIG. 1 is a block diagram that illustrates an exemplary communication setup between a management device and a network device, which may be utilized in accordance with an embodiment of the invention. Referring to FIG. 1, there is shown a management device 102, a network device 104, a management connection 106, a remote management agent 108, and a management service 110.

The management device 102 may comprise suitable logic, circuitry, and/or code that may enable management of network devices, for example the network device 104, via a management connection, for example the management connection 106. For example, the management device 102 may be utilized by Information Technology (IT) operators to enable management of various devices in an IT network. Additionally, the management device 102 may also comprise a dedicated entity, for example the remote management agent 108, to enable performing management operations. The management device 102 may perform management operations, via the remote management agent 108 for example, wherein the management device 102 may communicate with devices in an IT network to ensure availability of remote systems, to validate that systems may be up-to-date, and/or to perform any security patch updates that may be necessary. The management operations may be performed in-band, wherein the management device 102 may perform management operations via interactions with operating systems that may be running in the network devices. Alternatively, out-of-band management my be utilized, wherein the management device 102 may performed remote management operations in the independent of operating systems (OS) or the type of the platform of the network devices.

The remote management agent 108 may comprise logic, circuitry, and/or code that may enable performing management operation based on one or more management standards. For example, the remote management agent 108 may enable performing control and/or management operations, based on WS-Management and/or ASF protocols, of existing and/or known nodes, which support similar protocols, in a network.

The network device 104 may comprise suitable logic, circuitry, and/or code that may enable in-band and/or out-of-band management by one or more management devices, for example the management device 102, via a management connection, for example the management connection 106. The network device 104 may be integrated into a network that may be managed by the management device 102. For example, the network device 104 may comprise a personal computer (PC), in an IT network managed by the management device 102. Additionally, the network device 104 may also comprise a dedicated entity, for example the management service 110, to enable participating in management operations. In instances where an operating system (OS) may be run in the network device 104, and the OS may be running in the network device 104, in-band management of the network device 104 may be performed, wherein the OS running in the network device 104 may facilitate interactions between the network device 104 and the management device 102 in the course of the in-band management. Alternatively, the network device 104 may be enabled to participate in out-of-band management, wherein the network device 104 may be managed, by the management device 102 for example, independent of the OS in the network device 104, via the management service 110 for example.

The management service 110 may comprise logic, circuitry, and/or code that may enable performing management operation based on one or more management standards. For example, the management service 110 may enable participating in control and/or management operations, based on WS-Management and/or ASF protocols. The management service 110 may comprise a logical and/or software entity that may be integrated within an OS running in the network device 102, it may comprise a logical and/or software entity that may be integrated within a general network and/or internet controller (NIC) which may be running in the network device 102, or it may comprise a logical and/or software entity that may be integrated within a network controlled running within a dedicated management sub-system within the network device 104.

The management connection 106 may comprise interface and/or link that may enable interactions between management devices, for example the management device 102, and network devices such as the network device 104 to facilitated in-band and/or out-of-band management of the network devices by the management devices. The management connection 106 may utilize one or more standards-based management protocols. For example, the management connection 106 may comprise use of one or more management protocols specified and/or published by standards entities such as the Distributed Management Task Force (DMTF). The management connection 106 may comprise utilizing DMTF-based Alert Standard Format (ASF) protocol messaging and/or WS-Management (WS-Man) protocol messaging.

The Alert Standard Format (ASF) protocol may be utilized in first generation out-of-band management systems. The ASF protocol may comprise utilization of User Datagram Protocol (UDP) stack to enable communication between management devices and network devices. The ASF protocol may be perceived to lack sufficient security and/or reliability during out-of-band management operations. Devices comprising ASF functionality and/or interface may be ASF capable, wherein said devices may be managed, out-of-band, via ASF messages. For example, in instances where the network device 104 may be ASF capable, the management device 102 may utilize ASF based messaging to perform out-of-band management of the network device 104.

More recently, WS-Management (WS-MAN) was proposed and developed as the next generation of management protocol. The WS-Management is a specification based on Web Services, which typically utilize SOAP (XML based messaging) and HTTP(S) as a SOAP transport for communications. SOAP over HTTP(S) may require HTTP/TLS/TCP stack implementation, which may ensure improved security, reliability, and OS-independence. The DASH, a DMTF management standard work group, has defined a Common Information Model (CIM) based instrumentation, analogous to object oriented representation of management data, of a managed system that may be accessed using the WS-Management protocol. Devices that may comprise Intelligent Platform Management Interface (IPMI) or ASF internal interfaces/protocols may be capable, wherein said devices may be managed, out-of-band, via WS-Management messages. For example, in instances where the network device 104 may comprise IPMI or ASF based internal communications within the components of the network device 104, the management device 102 may utilize WS-Management based messaging to perform out-of-band management of the network device 104.

In operation, a management device, for example the management device 102, which may perform out-of-band management of WS-Management-capable devices, for example the network device 104, may attempt to communicate with the WS-Management-capable devices to discover supportability of WS-Management and available capabilities in the WS-Management-capable devices. The remote management agent 108 and/or the management service 110 may enable utilizing WS-management and/or ASF messaging, via the management connection 106, to enable out-of-band management operations between the management device 102 and the network device 104. Consequently, a two-phase mechanism may be utilized to enable the discovery of WS-Management-capable devices: 1) discovering the existence of WS-Management service in network devices in the first phase, and 2) discovering capabilities of discovered WS-Management services in the network devices in the second phase.

In the first phase, the management device 102 may utilize the management connection 106, via the remote management agent 108 and/or the management service 110 for example, to discover whether the network device 104 may support the WS-Management service. The management device 102 may utilize the message RMCP Presence Ping, as defined in the ASF protocol, to discover WS-Management service in the network device 104. The network device 104 may then utilize the RMCP Presence Pong message, as defined in the ASF protocol, to report, to the management device 102, WS-Management support in the network device 104. In instances where the management device 102 may have the MAC/IP address of the network device 104, the RMCP Presence Ping message may be sent to the network device 104 via unicast transmission that may be specifically limited to the network device 104. However, in instances where the management device 102 may not have prior knowledge of the MAC/IP of the network device 104, the RMCP Presence Ping message may be sent via broadcast (multicast) transmission. Additionally, in instances where the management device 102 may have prior knowledge of the MAC/IP of the network device and prior knowledge of whether the network device 104 may be ASF and/or WS-Management capable, the first phase may be concluded without any messaging between the network device 104 and the management device 102.

In the second phase, the management device 102 may utilize the management connection 106, via the remote management agent 108 and/or the management service 110 for example, to communicate directly with the network device 104 to determine capabilities of WS-Management services discovered in the network device 104 support WS-Management service. The management device 102 may determine after the first phase if the network device 104 is ASF capable and/or WS-Management capable. For example, the RMCP Presence Pong message may include information reporting if the network device 104 may be ASF and/or WS-Management capable. In instances where the network device 104 may only be WS-Management capable, the management device 102 may utilize WS-Management based messaging in determining capabilities of WS-Management services present in the network device 104. For example, the management device 102 may send a WS-Management Identity Request message to the network device 104 may reply with a WS-Management Identity Response message to the management service 102 with details on the capabilities of the WS-Management services in the network device 104.

In instances where the network device 104 may only be ASF capable, the management device 102 may have to use ASF messaging in determining capabilities of ASF services present in the network device 104. For example, the management device 102 may send a RMCP Capabilities Request message to the network device 104 may reply with a RMCP Capabilities Response message to the management service 102 with details on the capabilities of the ASF services in the network device 104.

Additionally, in instances where the network device 104 may be both ASF and WS-Management capable, the management device 102 may utilize both ASF and WS-Management messaging in determining capabilities of ASF and WS-Management services present in the network device 104.

In an alternate embodiment of the invention, the management device 102 may determine capabilities of WS-Management services discovered in the network device 104 support WS-Management service indirectly, via a separate entity. The network device 104 may advertise capabilities of WS-Management services in the network device 104 via a centralized catalog entity that may be accessed by the management device 102.

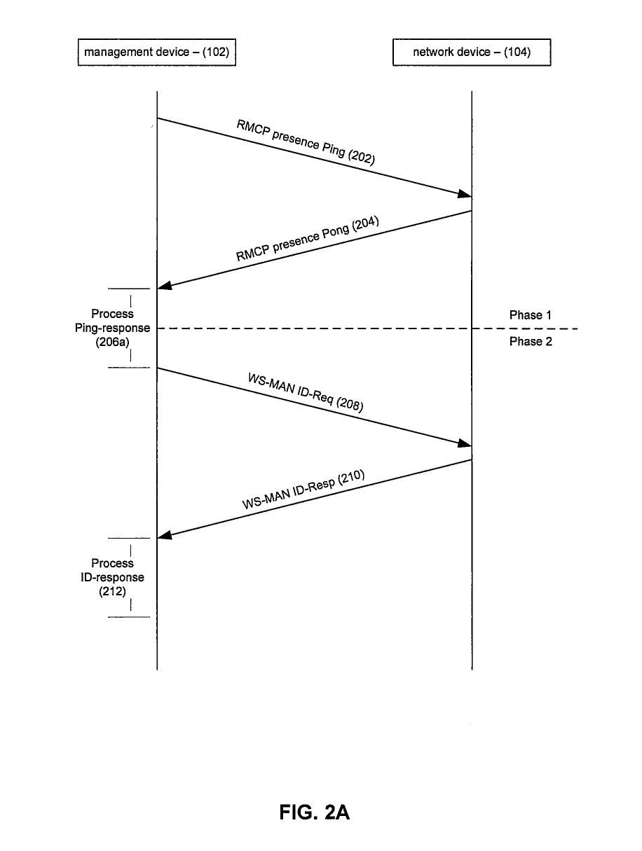

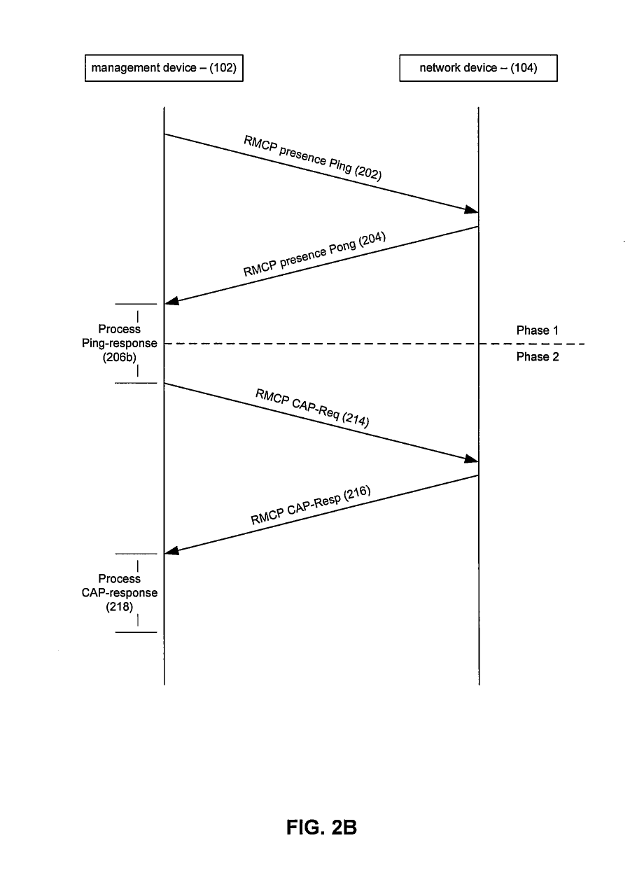

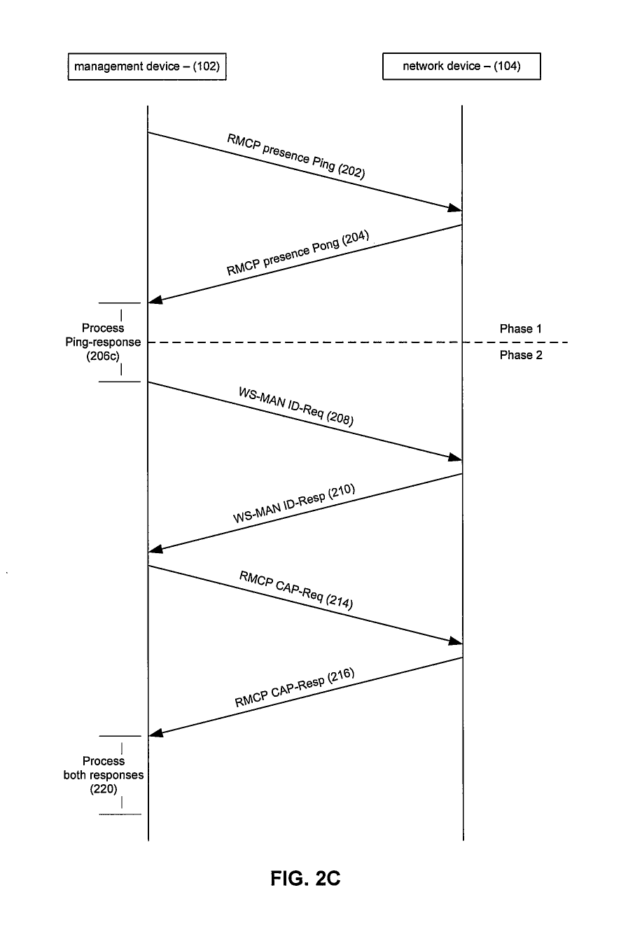

FIG. 2A is a flow diagram that illustrates exemplary messaging during out-of-band management between a management device and a network device via two-phase mechanism utilizing WS-Management service messaging in the second phase, in accordance with an embodiment of the invention. During out-of-band management operations between the management device 102 and the network device 104, the remote management agent 108 and/or the management service 110 may enable utilizing WS-management and/or ASF messaging, via the management connection 106, to enable out-of-band management operations between the management device 102 and the network device 104.

In step 202, the management device 102 may send a RMCP Presence Ping to the network device 104. In step 204, the network device 104 may reply to the management device 102 by sending a RMCP Presence Pong message. The RMCP Presence Pong message my comprise information that may indicate whether presence of WS-Management services in the network device 104, and/or whether the network device 104 may be ASF and/or WS-Management capable. In step 206a, the management device 102 may process the received RMCP Presence Pong message to enable determining presence of WS-Management services in the network device 104, and/or whether the network device 104 may be ASF and/or WS-Management capable. Where the management device 102 may determine, via the received RMCP Presence Pong message, that the network device 104 may only be WS-Management capable, for example comprising only WS-Management based messages may be utilized in determining capabilities of discovered services in the network device 104.

In step 208, the management device 102 may send a WS-MAN Identity Request message to the network device 104 to enable determining capabilities of WS-Management services that may be present in the network device 104. In step 210, the network device 104 may reply by sending a WS-MAN Identity Response message to the management service 102, which may comprise information on the capabilities of the WS-Management services in the network device 104.

In step 212 the management device 102 may process the received WS-MAN Identity Response message from the management service 102 to determine capabilities of the WS-Management services in the network device 104.

FIG. 2B is a flow diagram that illustrates exemplary messaging during out-of-band management between a management device and a network device via two-phase mechanism utilizing ASF messaging in the second phase, in accordance with an embodiment of the invention. During out-of-band management operations between the management device 102 and the network device 104, the remote management agent 108 and/or the management service 110 may enable utilizing WS-management and/or ASF messaging, via the management connection 106, to enable out-of-band management operations between the management device 102 and the network device 104.

In step 202, the management device 102 may send a RMCP Presence Ping to the network device 104, substantially as described in FIG. 2A. In step 204, the network device 104 may send a RMCP Presence Pong message to the management device 102, substantially as described in FIG. 2A. In step 206b, the management device 102 may process the received RMCP Presence Pong message to enable determining presence of WS-Management services in the network device 104, and/or whether the network device 104 may be ASF and/or WS-Management capable. Where the management device 102 may determine, via the received RMCP Presence Pong message, that the network device 104 may only be ASF capable, for example comprising only ASF interface support, only ASF based messages may be utilized in determining capabilities of discovered services in the network device 104.

In step 214, the management device 102 may send a RMCP Capabilities Request message to the network device 104 to enable determining capabilities of WS-Management services that may be present in the network device 104. In step 216, the network device 104 may reply by sending a RMCP Capabilities Response message to the management service 102, which may comprise information on the capabilities of the WS-Management services in the network device 104.

In step 218, the management device 102 may process the received RMCP Capabilities Response message from the management service 102 to determine capabilities of the ASF services in the network device 104.

FIG. 2C is a flow diagram that illustrates exemplary messaging during out-of-band management between a management device and a network device via two-phase mechanism utilizing both WS-Management service and ASF messaging in the second phase, in accordance with an embodiment of the invention. During out-of-band management operations between the management device 102 and the network device 104, the remote management agent 108 and/or the management service 110 may enable utilizing WS-management and/or ASF messaging, via the management connection 106, to enable out-of-band management operations between the management device 102 and the network device 104.

In step 202, the management device 102 may send a RMCP Presence Ping to the network device 104, substantially as described in FIG. 2A. In step 204, the network device 104 may send a RMCP Presence Pong message to the management device 102, substantially as described in FIG. 2A. In step 206c, the management device 102 may process the received RMCP Presence Pong message to enable determining presence of WS-Management services in the network device 104, and/or whether the network device 104 may be ASF and/or WS-Management capable. Where the management device 102 may determine, via the received RMCP Presence Pong message, that the network device 104 may be both ASF and WS-Management capable, the management device 102 may utilize both ASF and DWMG messaging in determining the capabilities of the WS-Management services that may be present in the network device 104.

In step 208, the management device 102 may send a WS-MAN Identity Request message to the network device 104 to enable determining capabilities of WS-Management services that may be present in the network device 104. In step 210, the network device 104 may reply by sending a WS-MAN Identity Response message to the management service 102, which may comprise information on the capabilities of the WS-Management services in the network device 104. In step 214, the management device 102 may send a RMCP Capabilities Request message to the network device 104 to enable determining capabilities of WS-Management services that may be present in the network device 104. In step 216, the network device 104 may reply by sending a RMCP Capabilities Response message to the management service 102, which may comprise information on the capabilities of the WS-Management services in the network device 104.

In step 220 the management device 102 may process the WS-MAN Identity Response and RMCP Capabilities Response messages received from the management service 102 to determine capabilities of the ASF and WS-Management services in the network device 104.

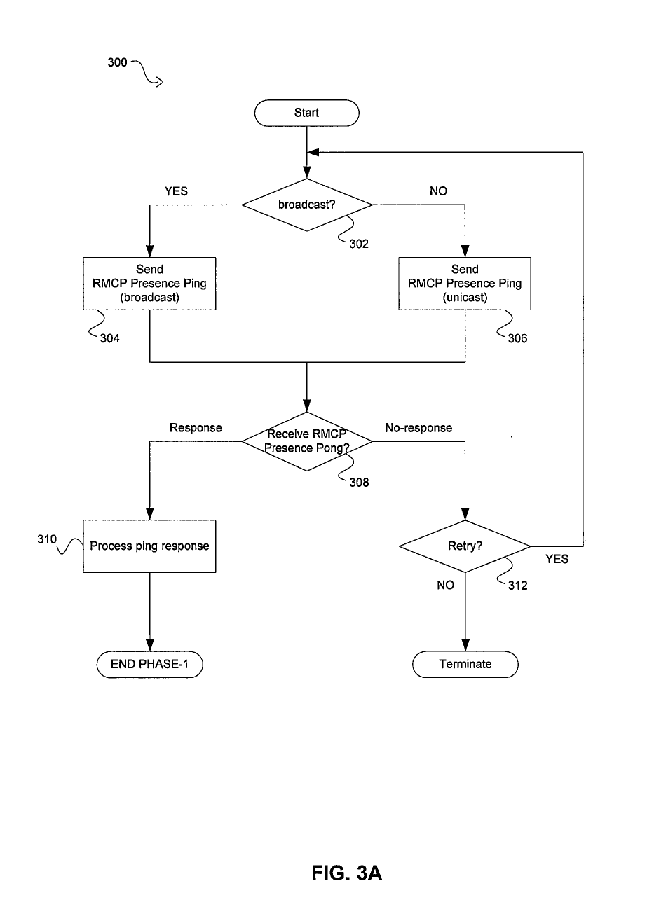

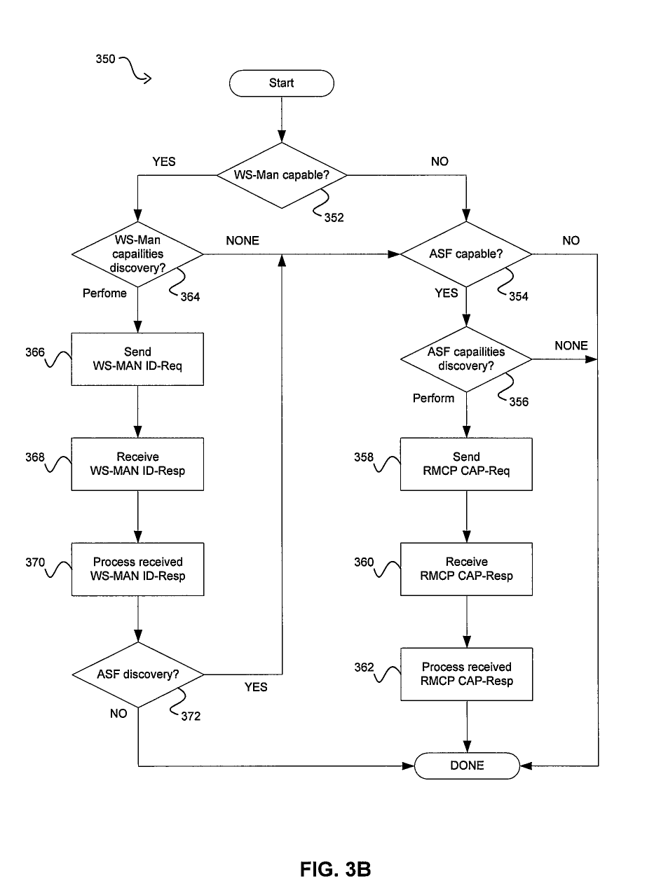

While FIG. 3C may show RMCP Capability Request/Response messaging being performed prior to performing WS-MAN Identity Request/Response messaging, no such limitation may be read into the current embodiment of the invention. The WS-MAN Identity Request/Response messaging may also be performed first; alternatively, the management device 102 may also send the RMCP Capability Request message and the WS-MAN Identity Request concurrently, and the network device 104 may then send the RMCP Capability Response message and/or the WS-MAN Identity Response based on order of reception of the request messages and/or based on pre-determined processing settings. Additionally, while FIG. 3C may show processing of both the WS-MAN Identity Response and RMCP Capabilities Response messages at the conclusion of both messaging sequences, in step 220, the management device 102 may instead process each response message when received, for example.

FIG. 3A is a flow diagram that illustrates a first phase of a two-phase mechanism that enables out-of-band management between a management device and a network device, in accordance with an embodiment of the invention. Referring to FIG. 3A, there is shown a flow chart 300 comprising a plurality of exemplary steps performed in a management devices, for example the management device 102, in the course of performing a first phase of a two-phase mechanism enabling out-of-band management.

In step 302, a determination whether to perform a ping broadcast, in the management device 102, may be performed. In instances where the MAC/IP address may not be available in the management device 102, or where the network device 102 may determine, via the remote management agent 108 for example, that ping broadcast may need be performed, the process may proceed to step 304. In step 304, a broadcast (multicast) transmission of a RMCP Presence Ping message to all network devices, wherein only devices that support specified WS-Management services in the RMCP Presence Ping may respond. The process may proceed to step 308.

Returning to step 302, in instances where the network device 102 may determine, via the remote management agent 108 for example, that ping broadcast need not be performed, and where the MAC/IP address may be available in the management device 102, the process may proceed to step 304. In step 304, a unicast transmission of a RMCP Presence Ping message, sent to a network device, for example the network device 104, based on available MAC/IP address may be performed. The process may then proceed to step 308. Where the management device 102 may desire to perform “ping sweep” of some or all of network devices with known MAC/IP addresses, transmission of unicast ping message to each of targeted network devices may be performed. The process may loop repeatedly at step 304 to perform all necessary unicast ping transmissions. Alternatively, the process may be looped, to enable performing necessary unicast messaging for remaining targeted network devices, at the conclusion of the first phase or at the conclusion of the second phase of out-of-band managements.

In step 308, a determination of whether RMCP Presence Pong message has been received in the management device 102 may be performed. The determination that there has been no reception of the RMCP Presence Pong message may be based on use of a timer, in the management device 102, for example. In instances where there has been a response to the RMCP Presence Ping message sent by the management device 102, the process may proceed to step 310. In step 310, a received RMCP Presence Pong message may be processed in the management device 102, wherein the first phase may then be concluded. The RMCP Presence Pong message may enable determining presence of WS-Management services in the network device 104, and/or whether the network device 104 may be ASF and/or WS-Management capable.

Returning to step 308, in instances where there has been no response to the RMCP Presence Ping message sent by the management device 102, the process may proceed to step 312. In step 312, a determination of whether a re-sending of the RMCP Presence Ping message, from the management device 102, may be determined. The determination of retry may be based on one or more factors. For example, the management device 102 may be setup so as not to retry failed ping operations. Alternatively, a pre-determined maximum number of retries may be reached with no successful reception of the RMCP Presence Pong messages. In instances where it was determined that the RMCP Presence Ping message may not be re-sent, the process may terminate.

Returning to step 312, in instances where the was a determination that the RMCP Presence Ping message may be re-sent, the process may proceed back to the step 302, and the process may be repeated.

FIG. 3B is a flow diagram that illustrates a second phase of a two-phase mechanism that enables out-of-band management between a management device and a network device, in accordance with an embodiment of the invention. Referring to FIG. 3B, there is shown a flow chart 350 comprising a plurality of exemplary steps performed in a management device, for example, the management device 102, in the course of performing a second phase of a two-phase mechanism enabling out-of-band management. The process may be initiated after a successful completion of the first phase, substantially as described in FIG. 3A. Alternatively, the process may be initiated based on prior knowledge, in the management device 102, of the MAC/IP address of the network device 104, and prior knowledge whether the network device 104 may be ASF and/or WS-Management capable.

In step 352, a determination of whether the network device 104 is WS-Management capable may be performed. The determination may be based on information derived from a received RMCP Presence Pong, for example, or it may be based on prior knowledge in the management device 102. In instances where the network device 104 may not be WS-Management capable, the process may proceed to step 354. In step 354, a determination of whether the network device 104 is ASF capable may be performed. The determination may be based on information derived from a received RMCP Presence Pong, for example, or it may be based on prior knowledge in the management device 102. In instance where the network device 104 may not be ASF capable, the process may end.

Returning to step 354, in instances where the network device 104 may be ASF capable, the process may proceed to step 356. In step 356, a determination of whether to perform ASF capabilities discovery may be performed. The determination may be based on information, about presence of ASF services in the network device 104, which may be derived from received RMCP Presence Pong and/or prior knowledge in the management device 102. In instances where it may be determined that ASF capabilities discovery may not be performed, the process may end.

Returning to step 356, in instances where it may be determined that ASF capabilities discovery may be performed, the process may proceed to step 358. In step 358, a RMCP Capabilities Request may be send, from the management device 102, to the network device 104, via the known MAC/IP address. A retry mechanism, similar to the retry mechanism utilized with the RMCP Presence Ping message, as described in steps 308 and 312 in FIG. 3A, may be utilized, in the management device 102, when sending RMCP Capabilities Request. In step 360, a RMCP Capabilities Response may be received, in the management device 102, from the network device 104. In step 362, processing of the received RMCP Capabilities Response message may be performed in the management device 102 to determine capabilities of the ASF services in the network device 104.

Returning to step 352, in instance where the network device 104 may be WS-Management capable, the process may proceed to step 364. In step 364, a determination of whether to perform WS-Management capabilities discovery may be performed. The determination may be based on information, about presence of WS-Management services in the network device 104, which may be derived from the received RMCP Presence Pong and/or prior knowledge in the management device 102. In instances where it may be determined that WS-Management capabilities discovery may not be performed, the process may be proceed to step 354, wherein ASF discovery may be performed.

Returning to step 364, in instances where it may be determined that WS-Management capabilities discovery may be performed, the process may proceed to step 356. In step 356, a WS-MAN Identity Request may be send, from the management device 102, to the network device 104, via the known MAC/IP address. Furthermore, because WS-Management may utilize SOAP via internet HTTP protocol, the WS-MAN Identity Request message may be sent to specific HTTP ports. For example, where the management device 102 may determine that non-secure communication may be sufficient and/or attainable, the WS-MAN Identity message may be sent to HTTP port 623. Alternatively, the WS-MAN Identity Request message may be sent to HTTP port 664 to enable secure communication. Additionally, a mechanism, similar to the retry mechanism utilized with RMCP Presence Ping message, as described in steps 308 and 312 in FIG. 3A, may be utilized, in the management device 102, when sending WS-MAN Identity Request message. In step 368, a WS-MAN Identity Response may be received, in the management device 102, from the network device 104. In step 370, a processing of received WS-MAN Identity Response message may be performed in the management device 102 to determine capabilities of the WS-Management services in the network device 104. In step 372, a determination whether to perform ASF discovery may be performed. The determination may be based on pre-determined setting in the management device 102 and/or availability of ASF services in the network device 104. In Instances where the ASF discovery may not be performed, the process may be done. Returning to step 372, in instances where the ASF discovery may be performed, the process may proceed to step 354, wherein ASF discovery may be performed.

Various embodiments of the invention may comprise a method and system for two-phase mechanism for discovering web services based management service. The management device 102 may first determine presence of WS-Management services in the network device 104, and may then discover capabilities of discovered WS-Management services in the network device 104. The management device, where the MAC/IP address of the network device is known, may utilize unicast ping mechanism to determine the presence of WS-Management services in the network device 104. In instances where the MAC/IP address of the network device may be unknown, the management device 102 may utilize broadcast ping mechanism to determine presence of WS-Management services in the network device 104. The discovery of capabilities of discovered WS-Management services may be performed via direct communication between the management device 102 and the network device 104. The direct communication may utilize WS-Management based messaging. Additionally, the direct communication between the management device 102 and the network device 104 may utilize specific HTTP ports when utilizing WS-Management based messaging. HTTP port 623 may be utilized for non-secure communication, and HTTP port 664 may be utilized for secure communications. In instances where it may be determined that there WS-Management and ASF services may coexist in the network device 104, the management device 102 may perform discovery of capabilities of ASF services in addition to discovery of capabilities of discovered WS-Management services, and the management device 102 may utilize ASF based messaging to perform said discovery of capabilities of discovered ASF services during direct communication between the management device 102 and the network device 104. The management device 102 may optionally discover capabilities of existing WS-Management and/or ASF services in the network device 104 indirectly. In this regard, the network device 104 may advertise capabilities of existing WS-Management and/or ASF services in the network device 104 via external entities.

Another embodiment of the invention may provide a machine-readable storage, having stored thereon, a computer program having at least one code section executable by a machine, thereby causing the machine to perform the steps as described herein for two-phase mechanism for discovering web services based management service.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for managing networks, the method comprising:
determining, via a management device, whether WS-Management service exists in a network device; and
discovering, via said management device, capabilities of said existing WS-Management service in said network device.

2. The method according to claim 1, comprising determining whether said WS-Management service exists in a network device utilizing a ping mechanism between said management device and said network device.

3. The method according to claim 2, wherein said ping mechanism comprises Alert Standard Format (ASF) RMCP ping and/or Alert Standard Format (ASF) RMCP pong messages.

4. The method according to claim 2, comprising transmitting unicast ping messages from said management device in instances where a MAC and/or an IP address of said network device is known, and/or where use of unicast ping message is pre-determined in said management device.

5. The method according to claim 2, comprising transmitting broadcast ping messages from said management device in instances where a MAC and/or an IP address of said network device is unknown, and/or where use of broadcast ping mechanism is pre-determined in said management device.

6. The method according to claim 1, comprising discovering said capabilities of said existing WS-Management service via direct communication between said management device and said network device.

7. The method according to claim 6, comprising discovering said capabilities of said existing WS-Management service via said direct communication between said management device and said network device utilizing WS-Management messaging.

8. The method according to claim 7, wherein said WS-Management messaging comprises WS-Management Identity Request and/or WS-Management Identity Response messages.

9. The method according to claim 6, comprising determining coexistence of WS-Management and ASF services in said network device prior to performing said direct communication said management device and said network device.

10. The method according to claim 9, comprising performing said direct communication between said management device and said network device in instances when there is coexistence of said WS-Management and said ASF services in said network device utilizing one or both of ASF messaging and WS-Management messaging.

11. The method according to claim 6, comprising performing said direct communication utilizing one or more pre-determined ports in said network device.

12. The method according to claim 11, wherein said one or more pre-determined ports comprise HTTP port 623 for non-secure communication and HTTP port 664 for secure communication.

13. The method according to claim 1, comprising performing said discovery of capabilities of said discovered WS-Management service via a central catalog service, wherein said one or more network device advertise said capabilities of said existing WS-Management via said central catalog service.

14. A system for managing networks, the system comprising:
one or more processors, in a management device, that enable determination of existence of WS-Management service in a network device; and
said one or more processors enable discovery of capabilities of said WS-Management service in said network device.

15. The system according to claim 14, wherein said one or more processor enable determination of whether said WS-Management service exists in a network device utilizing a ping mechanism between said management device and said network device.

16. The system according to claim 15, wherein said ping mechanism comprise Alert Standard Format (ASF) RMCP ping and/or Alert Standard Format (ASF) RMCP pong messages.

17. The system according to claim 15, wherein said one or more processor enable transmission of unicast ping messages from said management device, in instances where a MAC and/or an IP address of said network device is known, and/or where use of unicast ping messages is pre-determined in said network device.

18. The system according to claim 15, wherein said one or more processor enable transmission of broadcast ping messages from said management device, in instances where a MAC and/or an IP address of said network device is unknown, and/or where use of broadcast ping messages is pre-determined in said network device.

19. The system according to claim 14, wherein said one or more processor enable discovery of said capabilities of said existing WS-Management service via direct communication between said management device and said network device.

20. The system according to claim 19, wherein said one or more processor enable discovery of said capabilities of said existing WS-Management service via said direct communication between said management device and said network device utilizing WS-Management messaging.

21. The system according to claim 20, wherein said WS-Management messaging comprises WS-Management Identity Request and/or WS-Management Identity Response messages.

22. The system according to claim 19, wherein said one or more processor enable determination of coexistence of WS-Management and ASF services in said network device prior to performing said direct communication said management device and said network device.

23. The system according to claim 22, wherein said one or more processor enable performing of said direct communication between said management device and said network device in instances when there is coexistence of said WS-Management and said ASF services in said network device utilizing one or both of ASF messaging and WS-Management messaging.

24. The system according to claim 19, wherein said one or more processor enable performing of said direct communication utilizing one or more pre-determined ports in said network device.

25. The system according to claim 14, wherein said one or more processor enable performing of said discovery of capabilities of said discovered WS-Management service via a central catalog service, wherein said one or more network device advertise said capabilities of said existing WS-Management via said central catalog service.
